(19) United States
(12) Patent Application Publication
(10) Pub. No.: US 2010/0124601 A1
(43) Pub. Date: May 20, 2010

(54) PATTERN FORMATION METHOD AND COMPUTER PROGRAM PRODUCT

(76) Inventors: Takumi OTA, Yokohama-shi (JP); Ikuo Yoneda, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/564,864

(22) Filed: Sep. 22, 2009

(30) Foreign Application Priority Data
Nov. 19, 2008 (JP) 2008-296050

(51) Int. Cl. B05D 5/00

(52) U.S. Cl. 427/8; 427/256

(57) ABSTRACT

A pattern forming method includes calculating amount of curable resin to be formed on a substrate, forming curable resin having the calculated amount on the substrate, filling a pattern of the template with the curable resin on the substrate by contacting the template with the curable resin on the substrate, curing the curable resin with the template being contacted with the curable resin, forming a pattern in the cured curable resin, which includes separating the template from the cured curable resin, and forming a pattern on the substrate based on the pattern formed in the curable resin, wherein the calculating the amount of curable resin to be formed on the substrate is performed based on a relationship between density or shape of a pattern to be formed on the template and filling time for filling the pattern to be formed on the template with the curable resin.

### CROSS-REFERENCE TO RELATED APPLICATIONS

This application is based upon and claims the benefit of priority from prior Japanese Patent Application No. 2008-296050, filed Nov. 19, 2008, the entire contents of which are incorporated herein by reference.

### BACKGROUND OF THE INVENTION

1. Field of the Invention

The invention relates to a pattern formation method including forming a pattern on a substrate and a computer program product.

2. Description of the Related Art

In the manufacture of semiconductor devices, as one technology to cope with both the formation of fine patterns of 100 nm or less and mass productivity, attention has been paid to imprint technologies which involve transferring pattern of a template (which is also called a mold or an original plate) onto a substrate.

One of the imprint technologies is optical (UV) nanoimprint. The nanoimprint technology involves applying a light curable resin onto a substrate to be processed, aligning the substrate and the template (alignment), bringing the template into direct contact with the light curable resin (imprint), irradiating the light curable resin with light to cure it, separating the template from the cured light curable resin (resin pattern), and etching the substrate using the resin pattern as a mask (Jpn. Pat. Appln. KOKAI Publication No. 2000-194142).

One method to apply the light curable resin onto the substrate to be processed is to form the light curable resin on the substrate by ink jet method. With this method, the light curable resin is formed on each of regions of the substrate. The template is brought into contact with the light curable resin. In this state, it is required to wait until concave portions of a concave-convex pattern formed on the template are filled with the light curable resin. If the waiting time (filling time) is insufficient, there would be produced portions which are not filled with the light curable resin. If the light curable resin were irradiated with light with unfilled portions left, the unfilled portions would become pattern defects (unfilled defects) depending on their size or shape.

### BRIEF SUMMARY OF THE INVENTION

According to an aspect of the present invention, there is provided a pattern forming method comprising: forming curable resin having the calculated amount on the substrate; filling a pattern of the template with the curable resin on the substrate by contacting the template with the curable resin on the substrate; curing the curable resin with the template being contacted with the curable resin; forming a pattern in the cured curable resin, which includes separating the template from the cured curable resin; and forming a pattern on the substrate based on the pattern formed in the curable resin; wherein the calculating the amount of curable resin to be formed on the substrate is performed based on a relationship between density or shape of a pattern to be formed on the template and filling time for filling the pattern to be formed on the template with the curable resin.

According to another aspect of the present invention, there is provided a pattern forming method comprising: calculating amount of curable resin to be formed on a substrate; forming curable resin having the calculated amount on the substrate; filling a pattern of the template with the curable resin on the substrate by contacting the template with the curable resin on the substrate; curing the curable resin with the template being contacted with the curable resin; forming a pattern in the cured curable resin, which includes separating the template from the cured curable resin; and wherein the calculating the amount of curable resin to be formed on the substrate includes dividing the pattern to be formed on the template into a plurality of pattern regions, determining amount of curable resin for each of a plurality of regions of the substrate, wherein the plurality of regions of the substrate contact the plurality of pattern regions of the pattern of the template when the template is contacted with the curable resin, determining whether the pattern of the template is filled with the curable resin having the determined amount within predetermined time for each of the plurality of pattern regions of the template, and correcting the determined amount of the curable resin when it is determined that a pattern region not being filled with the curable resin exists in the plurality of pattern regions of the template, the correcting the determined amount of the curable resin comprises increasing the determined amount of the curable resin on a region of the substrate, the region of the substrate contacting a pattern region neighboring the pattern region not being filled with curable resin.

According to an aspect of the present invention, there is provided a computer program product configured to store program instructions for execution on a computer system enabling the computer system to perform: an instruction to dividing a pattern to be formed on a template into a plurality of pattern regions, an instruction to determine amount of curable resin for each of a plurality of regions of a substrate, wherein the plurality of regions of the substrate contact the plurality of pattern regions of the pattern when the template is contacted with the curable resin, an instruction to determine whether the pattern of the template is filled with the curable resin having the determined amount within predetermined time for each of the plurality of pattern regions, and an instruction to correct the determined amount of the curable resin when the plurality of pattern regions includes a pattern region which is determined not to be filled with the curable resin within the predetermined time, wherein the correcting the determined amount is performed based on the relationship between the density or shape of the pattern to be formed on the template and the filling time for filling the pattern to be formed on the template.

### BRIEF DESCRIPTION OF THE SEVERAL VIEWS OF THE DRAWING

FIG. 1 is a flowchart illustrating a pattern formation method using a nanoimprint method according to a first embodiment;

FIG. 2 is a plan view for explaining a determination method whether or not filling time is acceptable or not on a basis of a pattern density in mesh according to the first embodiment;

FIG. 3 shows the relationship between pattern size and filling time of a contact hole and a line and space pattern;

FIG. 4 is a plan view for explaining an example of a correcting method for dropping amount of light curable resin according to the first embodiment;

FIG. 5 is a plan view illustrating an example of arrangement of regions having different pattern densities;

FIG. 6 is a plan view for explaining an inspection method for a pattern forming method using a nanoimprint method of a second embodiment; and

FIG. 7 is a diagram for explaining a computer program product of an embodiment.

### DETAILED DESCRIPTION OF THE INVENTION

The embodiments of the present invention will be described hereinafter with reference to the accompanying drawings.

### First Embodiment

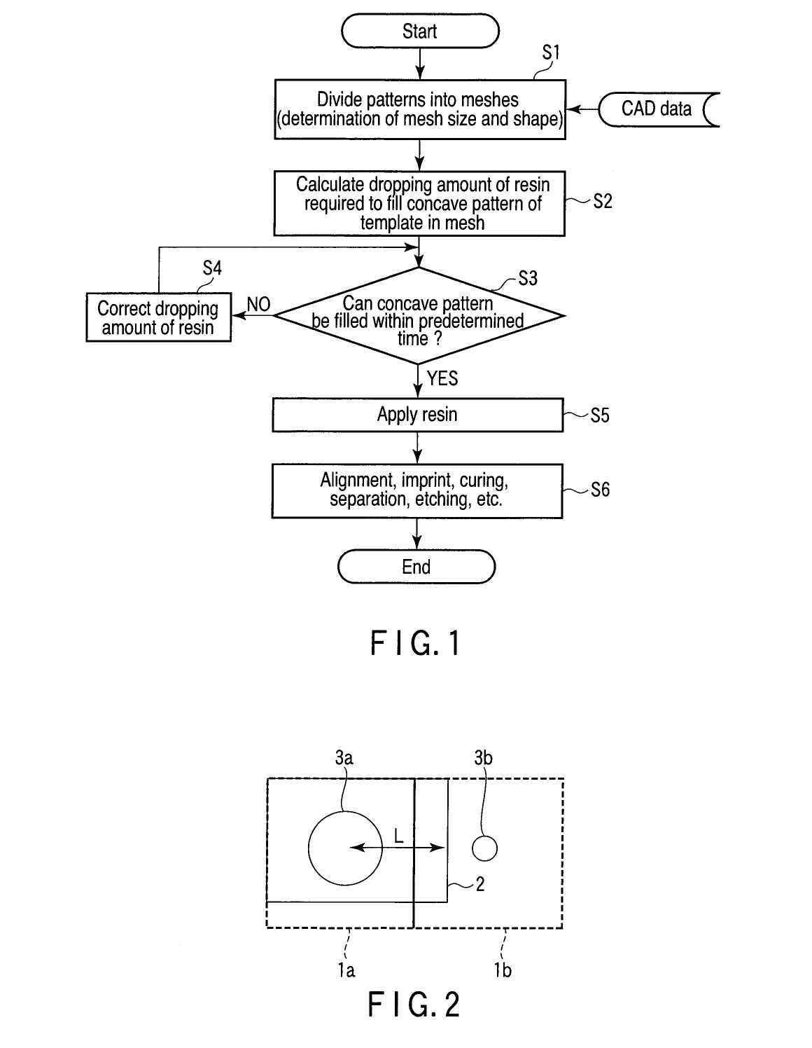

FIG. 1 is a flowchart illustrating a pattern formation method using a nanoimprint method according to a first embodiment. The present embodiment will be described in terms of an example of applying a light curable resin by ink jet method onto a plurality of regions of a substrate to be processed.

The light curable resin is cured by light irradiation, but it is also possible to use other resin which is cured by method other than light irradiation such as resin that is cured by heating (heat curable resin) for instance.

[Step S1]

A pattern to be formed on a template is divided into meshes. In more detail, a pattern on data expressed in a given format is divided. The data is given in a format of CAD data for example. Here, the pattern is divided into meshes each having a rectangular shape and each measuring the minimum movable pitch (mesh size) of dispenser on a side. The pattern here is a pattern to be formed in the light curable resin (resin pattern) which is used as an etching mask.

The substrate to be processed is, for example, a silicon or SOI substrate (semiconductor substrate). The substrate to be processed may be a multilayer structure. For example, the substrate may be comprised of the above-mentioned semiconductor substrate and a conductive or insulating layer formed on the substrate (a substrate of multilayer structure). The conductive layer is, for example, a metal layer, a polysilicon layer to be a gate. The insulating layer is, for example, a silicon nitride layer or a silicon oxide layer to be a hard mask.

[Step S2]

In order to calculate dropping amount of light curable resin required to form the pattern, the dropping amount of light curable resin needed for filling the concave portion of concave-convex pattern of the template in the mesh at the time of imprint step (step of contacting template with light curable resin) is calculated for each of the meshes.

The calculation of the dropping amount of the light curable resin is performed on a basis of the density of concave portion of the concave-convex pattern (pattern density) in each meshes at the time of imprint. Relating to a ration of contacting area of concave portion of the concave-convex pattern of the template to the mesh, the higher the pattern density of the mesh, the higher the ration of contacting area of the concave portion to the mesh becomes. The mesh with higher pattern density, the more the amount of light curable resin is needed for filling the concave portion of the concave-convex pattern. Therefore, in general, the mesh with higher pattern density, the larger the dropping amount of the light curable resin is calculated.

[Step S3]

It is determined whether the concave pattern of the template is filled with the curable resin having the dropping amount calculated in step S2 within previously determined filling time (predetermined time) at the time of imprint for each of the meshes.

The determination is performed as follows.

With reference to FIG. 2, the method for determining whether or not the filling time is acceptable or not based on the pattern density in the mesh will be explained.

In FIG. 2, there are illustrated two meshes 1a and 1b. The occupation ratio of concave pattern 2 to the mesh 1a is higher than the occupation ratio of concave pattern 2 to the mesh 1b. Therefore, according to the pattern density (density of concave portion to be filled), the dropping amount of light curable resin 3a in the mesh 1a is larger than that of light curable resin 3b in the mesh 1b.

The dropping amount of the light curable resin of the mesh indicates the amount of curable resin to be dropped on the regions of the substrate, wherein the regions of the substrate contact the template regions corresponding to the pattern regions in the form of meshes for the division when the template is contacted with the curable resin formed on the substrate for instance.

In a case of FIG. 2, since the mesh 1a is larger in pattern density than the mesh 1b, the filling speed of the light curable resin in the mesh 1a will be lower than in the mesh 1b because of the capillary phenomenon. For this reason, when the light curable resins 3a and 3b having the magnitude relation of amount shown in FIG. 2, there arises the possibility that filling continues in the mesh 1a even after filling has finished in the mesh 1b. That is, there is the possibility that filling may not finish within the predetermined time in the mesh 1a.

For example, considering the distance L from the resin dropping position in the mesh 1a to the edge of the concave pattern 2 (pattern edge) as shown in FIG. 2, it is considered that the pattern density in the mesh 1a decreases as the distance L decreases. Accordingly, the pattern density in the mesh 1a can be easily estimated on the basis of the distance L. The relationship between the pattern density in the mesh and the dropping amount of resin in the mesh is calculated based on a filling experiment or a filling simulation.

In addition, since fine patterns (concaves) exist in the concave pattern area 2, the pattern density in each of the meshes 1a and 1b can be estimated more accurately based on the fine patterns. Concretely, the pattern densities of the meshes 1a and 1b are respectively estimated by obtaining total area of concaves of the concave pattern 2 in meshes 1a and 1b. In the future, as the sizes of the meshes 1a and 1b are reduced, the only one fine pattern (concave) may exist in the concave pattern 2.

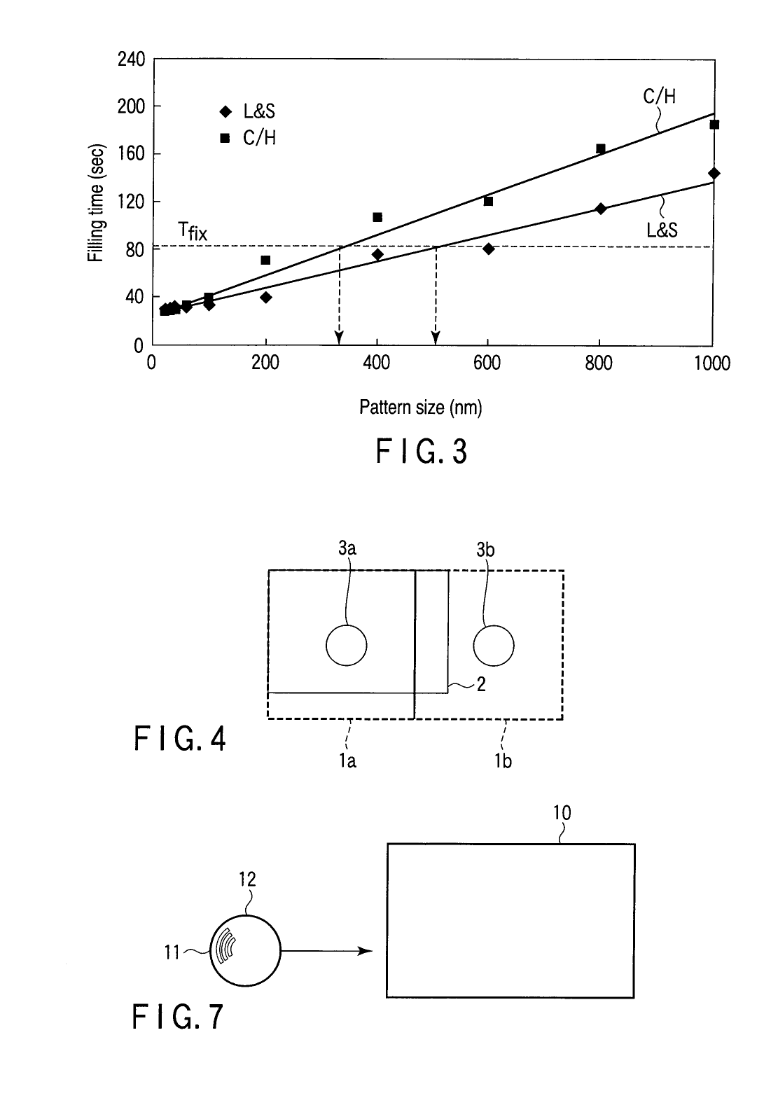

With reference to FIG. 3, the method for determining whether or not the filling time is acceptable or not based on the shape of concave pattern (pattern shape) of the template in the mesh will be explained.

FIG. 3 shows the relationship between the pattern size and the filling time relating to a line and space pattern (L&S) and a contact hole pattern (CH), which are different in shape The pattern size of L&S is a distance between line and space, the pattern size of CH is a diameter of contact hole.

From FIG. 3 it can be seen that, for the same pattern size, L&S is shorter in filling time than CH. When the pattern size is 400 nm, it can be seen that L&S can be filled within the predetermined time T_{fix}, but CH cannot be filled. As the predetermined time T_{fix} is fixed in nanoimprint method, the predetermined time T_{fix} cannot be varied between L&S and CH. Since the size of a pattern to be formed and the predetermined time T_{fix} are known in advance, the determination can be made in step S3 as to whether it is possible to fill the concave pattern in mesh with the light curable resin within the predetermined time based on the shape of concave pattern (pattern shape) of the template in mesh.

There is a method of determining the predetermined time T_{fix} in conformity with CH which has longer filling time. However, this method has a problem of reduced throughput. The relationship between the pattern shape in mesh and the dropping amount of resin in mesh is calculated based on a filling experiment or a filling simulation.

[Step S4]

As to the mesh determined not acceptable in the determination of step S3, the dropping amount of the curable resin calculated in step S2 is corrected such that the concave patter is filled with the light curable resin in the predetermined time. There is possibility that an unfilled portion is generated in the concave pattern relating to the mesh determined not acceptable. Such the unfilled portion may cause pattern defect (unfilled defect). So, in the present embodiment, the present step (step S4) is provided to correct the dropping amount of the light curable resin so that the concave pattern is filled with the light curable resin within the predetermined time.

With reference to FIG. 4, an example of the method for correcting the dropping amount of the light curable resin will be explained concretely. This correction method is an example in the case of determining whether the filling time is acceptable or not based on the pattern density in mesh in step S3 (FIG. 2).

As described above, in the case of FIG. 2, the dropping amount of the light curable resin in the mesh 1a is larger than the dropping amount of the light curable resin in the mesh 1b and the filling speed in the mesh 1a is lower than the filling speed in the mesh 1b, thus, there is the possibility that the filling is not finished within the predetermined time in the mesh 1a. That is, the mesh 1a leads to an unfilled pattern after the predetermined time elapses.

If the filling is not finished within the predetermined time in the mesh 1a, as shown in FIG. 4, the dropping amount of the light curable resin 3b to be dropped on the mesh 1b is set larger than the amount required to fill the concave pattern in the mesh 1b. On the other hand, as shown in FIG. 4, the dropping amount of the light curable resin 3a to be dropped on the mesh 1a may be reduced. However, there is a case that it is not required to decrease the dropping amount of the light curable resin 3a to be dropped on the mesh 1a.

Thereby, the light curable resin for filling the concave pattern in the mesh 1a is also supplied from the mesh 1b, the filling time for the concave pattern in the mesh 1a is shortened. There is a possibility that the light curable resin 3b in the mesh 1b may be supplied to adjacent meshes not shown. However, due to the flattening phenomenon of resin, the thickness of light curable resin in the adjacent meshes not shown will not be excessively increased in general, then the thickness will fall into an acceptable range, thus the supply of light curable resin 3b to the adjacent meshes does not case drawback.

Therefore, as to the mesh determined not acceptable in the step S3 (NG mesh), the dropping amounts of the light curable resin in the NG mesh (mesh 1a in FIG. 4) and the adjacent mesh (mesh 1b in FIG. 4) are corrected such that the filling time of concave pattern of the NG mesh falls in the predetermined time. This correction can be made on the basis of the relationship among the pattern density, the dropping amount of the light curable resin and the filing time of the predetermined mesh and its adjacent mesh. The relationship is previously obtained by experiment, calculation (simulation), or both experiment and calculation (simulation). The previously obtained relationship is, for example, expressed in a table (rule) or an arithmetic (model). The dropping position of resin may be added in the relationship.

In addition, when the determination whether or not the filling time is acceptable or not is performed based on the pattern shape in the mesh in step s3, the dropping amount of resin is similarly corrected based on the relationship among the pattern shape, the dropping amount of resin and the filling time.

For example, when the ratio of a contact hole pattern and a line and space pattern varies between the predetermined neighboring mesh areas, the amounts of the light curable rein to be dropped on both the meshes can be corrected. That is, according to FIG. 3, the pattern in the mesh region with a high ration of contact hole pattern takes longer filling time than the pattern in the neighboring mesh region with a high ration of line and space pattern. For this reason, the amount of the light curable rein to be dropped on the neighboring mesh region with the high ration of line and space pattern can be corrected so as to be increased. Thereby, the filling time of the pattern in the mesh region with the high ration of line and space pattern can be reduced. At the time of this correction, the amount of the light curable rein to be dropped on the mesh region with the high ration of contact hole pattern can also be corrected so as to be decreased.

Relating to the correction amount, it is obtained based on the relationship among the pattern shape, the resin dropping amount and the filling time, just like the relationship among the pattern density, the resin dropping amount and the filling time mentioned above.

However, the correction needs not necessarily to be made on the basis of the pattern density or the pattern shape. That is, when the region to be an unfilled pattern region can be identified by filling experiment or filling simulation, the amount of resin to be formed on a region of the substrate, in which the region corresponds to a pattern region neighboring the unfilled pattern region, is increased. Thereby, it becomes possible to complete the filling of resin into the pattern within the predetermined time. At this time, it is also possible to reduce the amount of resin on a region of the substrate, in which the region corresponds to the unfilled pattern region.

[Step S5]

If the decision in step S3 is YES for all the meshes, then the calculated amounts of light curable resin are dropped on the substrate to be processed.

In a case that the amount of resin is previously calculated based on the pattern density or pattern shape, the drop amount of resin and the filling time in the present embodiment, the determination step S3 and the correction step 4 in FIG. 1 can be omitted and the amount of resin for filling the concave pattern in the predetermined time can be calculated in step S2.

[Step S6]

After the step S5, known steps, such as an alignment step, an imprint step, a curing step, a releasing step, an etching step, etc., are carried out to form patterns on the substrate.

The alignment step, the imprint step, the curing step, the releasing step, the etching step, and other steps will be described briefly.

In the alignment step, the template is aligned with the substrate to be processed. The template comprises a transparent substrate with a pattern (concave pattern) formed on a surface thereof. The transparent substrate is, for example, a quartz substrate. The concave pattern corresponds to the pattern to be formed on the substrate to be processed.

In the imprint step, the template is directly contacted with the light curable resin. At this time, the light curable resin is left thinly between projections of the template and the substrate (in gap). This light curable resin left thinly is to be a remnant film.

In the curing step, the light curable resin is cured by irradiating the light curable resin with light.

In the releasing step, the template is released from the light curable resin.

In the etching step, the remnant film is removed by anisotropic etching using oxygen plasma mainly to form a pattern comprising the cured curable light resin (resin pattern), further, by using the pattern as an etching mask, the substrate is etched to form a fine pattern on the substrate.

The other steps include an inspection step performed after the releasing step to inspect defect of the pattern and a removing step performed after the etching step to remove the etching mask (resin patterns).

As mentioned above, in the present embodiment, the dropping amounts of light curable resin for meshes calculated in step S2 are sufficient to fill the concave patterns of the meshes, which are not necessarily optimized from the viewpoint of filling time, but the determination and correction of the dropping amounts in steps S3 and S4 are performed such that the concave patterns of the meshes are filled within the predetermined time, hence the pattern forming method using the ink jet type of nanoimprint method which can suppress the pattern defect (unfilled defect) caused by generation of the unfilled portion of the light curable resin in the concave pattern. Other methods than the ink jet method may be used to drop resins on the regions of the substrate to be processed.

In addition, the dropping amount of light curable resin calculated for each of the meshes in step S2 is calculated based on the density of pattern to be formed on the template, but it not necessarily calculated based on the pattern density. It may be determined based on the at least one of factors which includes the pattern density, volatilization amount of resin, the position and depth of pattern formed on the template, and the thickness of resin after the releasing of template required for the remnant film for instance.

### Second Embodiment

Next, a pattern forming method using an imprint method according to a second embodiment will be described. The present embodiment is different from the first embodiment the inspection step which is mentioned as one example of the other steps.

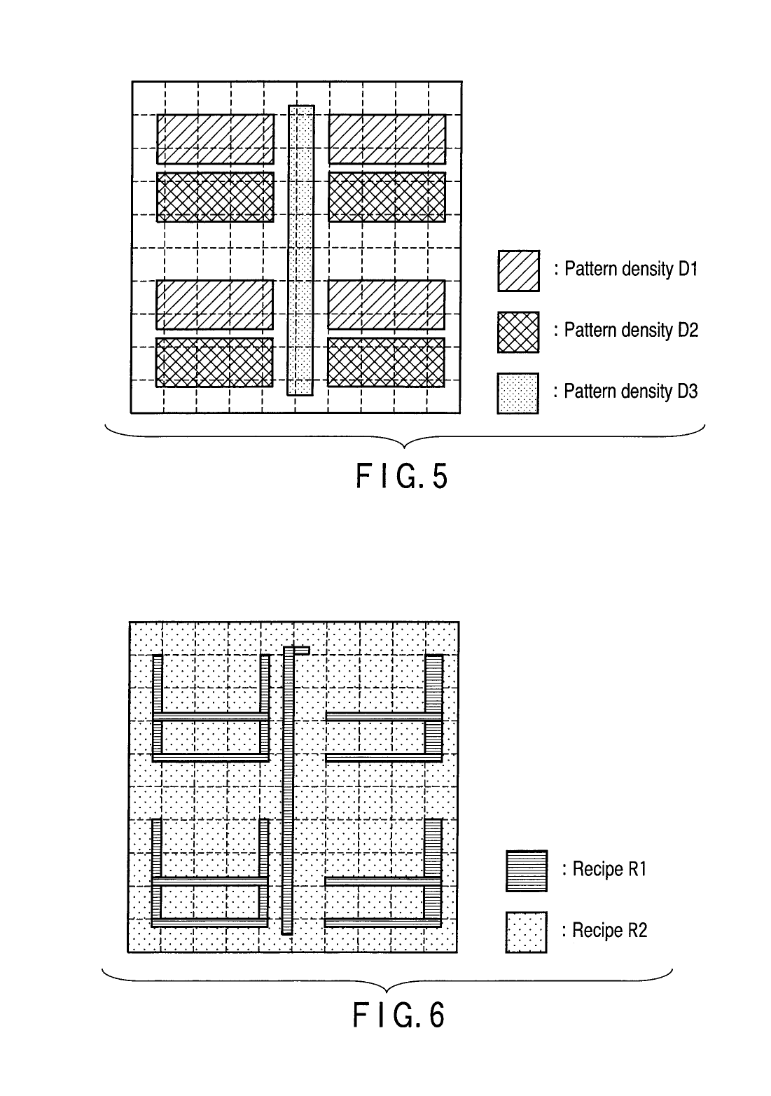

First, an inspection step in comparative example will be described. As shown in FIG. 5, in the comparative example, even if regions (shown by dashed lines) of different pattern densities D1, D2 and D3 are arranged in a chip, the regions are inspected with the same inspection sensitivity of a certain level or more. In FIG. 5, the regions are meshes having rectangular shapes and measuring the minimum movable pitch (mesh size) of dispenser on a side.

Here, when the regions of different pattern densities are inspected with the same inspection sensitivity of a certain level or more, the inspection step takes time. This point will be described below.

The inspection step is firstly performed by using an optical inspection apparatus. In the inspection using this optical inspection apparatus, all the regions different in pattern density are inspected with the same inspection sensitivity of a certain level or more.

At the time of inspection using the optical inspection apparatus, defect called false defect may be detected. The false defect is not defect which has serious adverse effects on a semiconductor device to be manufactured, for example, a defect that causes the semiconductor device not to meet allowable specifications such as electrical characteristics, but the false defect is a portion which is misidentified as a defect. In general, the higher the inspection sensitivity of the optical inspection apparatus is set, the more the false defects are detected.

Next, the defects detected by the optical inspection apparatus are inspected more accurately by using an inspection apparatus (e.g., an inspection apparatus using an electron beam) which is higher in accuracy than the optical inspection apparatus. At this stage, each of the defects is determined whether it is the false defect or not. The more the false defects, the longer the inspection at this stage takes time.

Therefore, the comparative example, which inspects the regions having different pattern densities by the optical inspection apparatus with the same inspection sensitivity of a certain level or more, tends to detect many false defects, and the comparative example results in requiring a long time for the inspection step.

At the stage of examination prior to manufacture devices at the product level, it is sometimes required to inspect quickly. Thus, the time-consuming inspection method of the comparative example is not suited as the inspection method at the stage of examination.

Hence, in the present embodiment, considering the portions which tend to generate the true defects also tend to generate the false defects, then only the portions which tend to generate the true defects are inspected by optical inspection apparatus with its inspection sensitivity lowered.

Here, to cite an example of the portion which tends to generate the defect, there is the portion which tends to generate the unfilled defect, whose pattern edge is distant from the dropping position of light curable resin. Accordingly, when the regions having different pattern densities of D1, D2 and D3 are arranged as shown in FIG. 5, the portion having the distant pattern edge is inspected according to recipe R1 in which the inspection sensitivity is a low level, and other portions are inspected according to recipe R2 in which the inspection sensitivity is a normal level, as shown in FIG. 6.

According to the present embodiment as described above, the time required for the inspection step is reduced by adopting the inspection method that adjusts the inspection sensitivity according to the inspection portions in the case that there exists the regions having the different pattern densities, in which the portion which tends to generate defects is inspected with the inspection sensitivity lowered, not inspecting all the regions having the different pattern densities with the same inspection sensitivity. Also, other similar effects as those obtained in the first embodiment are obtained in this embodiment.

The method for calculating the amounts of light curable resin in the pattern forming methods of the embodiments can also be carried out in the form of a computer program product 12 that contains a program 11 for executing a system including a computer 10. For example, the computer program product 12 causes the computer 10 to execute instructions corresponding to steps S1 through S4 of FIG. 1.

In addition, the computer program product 12 may be modified as follows. That is, the computer program product 12 may be modified such that causes the computer to excuse only the instructions corresponding to steps S1 and S4. The computer program product 12 may be modified to be separated into two parts, in which one is one is a curable resin amount calculation program product that causes the computer to excuse only the instruction corresponding to step S2, and other is a computer program product that causes the computer to excuse only the instructions corresponding to steps S3 and S4 or a corrected curable resin amount calculation program product that causes the computer to excuse only the instruction corresponding to steps S4. The computer program product 12 is, for example, a CD-ROM or DVD.

The program 11 is executed using hardware resources, such as a CPU and memory in the computer (external memory may be concurrently used for the memory, depending on the case). The CPU reads necessary data from the memory, and executes the instruction or the instructions for the read data. The result of the respective instruction is temporarily stored by necessary in the memory, and is read out when it is required in the other instruction.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A pattern forming method comprising:
calculating amount of curable resin to be formed on a substrate;
forming curable resin having the calculated amount on the substrate;
filling a pattern of the template with the curable resin on the substrate by contacting the template with the curable resin on the substrate;
curing the curable resin with the template being contacted with the curable resin;
forming a pattern in the cured curable resin, which includes separating the template from the cured curable resin; and
forming a pattern on the substrate based on the pattern formed in the curable resin;
wherein the calculating the amount of curable resin to be formed on the substrate is performed based on a relationship between density or shape of a pattern to be formed on the template and filling time for filling the pattern to be formed on the template with the curable resin.

2. The pattern forming method according to claim 1,
wherein the calculating the amount of curable resin to be formed on the substrate includes
dividing the pattern to be formed on the template into a plurality of pattern regions,
determining amount of curable resin for each of a plurality of regions of the substrate, wherein the plurality of regions of the substrate contact the plurality of pattern regions of the pattern when the template is contacted with the curable resin,
determining whether the pattern of the template is filled with the curable resin having the determined amount within predetermined time for each of the plurality of pattern regions, and
correcting the determined amount of the curable resin when the plurality of pattern regions includes a pattern region which is determined not to be filled with the curable resin within the predetermined time, wherein the correcting the determined amount is performed based on the relationship between the density or shape of the pattern to be formed on the template and the filling time for filling the pattern to be formed on the template.

3. The pattern forming method according to claim 1, wherein the substrate includes a semiconductor substrate.

4. The pattern forming method according to claim 1, wherein the curable resin includes resin capable of being cured by light irradiation or heating.

5. The pattern forming according to claim 1, wherein the curable resin is formed on the substrate by ink jet.

6. The pattern forming method according to claim 1, wherein the pattern to be formed on the template includes a concave-convex pattern, the density of the pattern to be formed on the template is a density of concave portions of the concave-convex pattern.

7. The pattern forming method according to claim 1, wherein the pattern to be formed on the template includes a line and space pattern, and a contact hole pattern.

8. The pattern forming method according to claim 1, wherein when the plurality of pattern regions are determined to be filled with the curable resin within the in the determining, resin having the calculated amount is formed on the substrate.

9. The pattern forming method according to claim 1, further comprising inspecting the pattern formed on the substrate after the template is released from the cured curable resin.

10. The pattern forming method according to claim 9, wherein the inspecting the includes changing inspection sensitivity in accordance with density of the pattern in the plurality of pattern regions, the inspection sensitivity includes a first inspection sensitivity and a second inspection sensitivity lower than the first inspection sensitivity, density of the pattern in the plurality of pattern regions inspected by the second inspection sensitivity is lower than density of the pattern in the plurality of pattern regions inspected by the first inspection sensitivity.

11. The pattern forming method according to claim 1, wherein the pattern in the plurality of pattern regions inspected by the first and second inspections are inspected by optical inspection apparatus.

12. A pattern forming method comprising:
calculating amount of curable resin to be formed on a substrate;
forming curable resin having the calculated amount on the substrate;
filling a pattern of the template with the curable resin on the substrate by contacting the template with the curable resin on the substrate;
curing the curable resin with the template being contacted with the curable resin;
forming a pattern in the cured curable resin, which includes separating the template from the cured curable resin; and
wherein the calculating the amount of curable resin to be formed on the substrate includes
dividing the pattern to be formed on the template into a plurality of pattern regions,
determining amount of curable resin for each of a plurality of regions of the substrate, wherein the plurality of regions of the substrate contact the plurality of pattern regions of the pattern of the template when the template is contacted with the curable resin,
determining whether the pattern of the template is filled with the curable resin having the determined amount within predetermined time for each of the plurality of pattern regions of the template, and
correcting the determined amount of the curable resin when it is determined that a pattern region not being filled with the curable resin exists in the plurality of pattern regions of the template, the correcting the determined amount of the curable resin comprises increasing the determined amount of the curable resin on a region of the substrate, the region of the substrate contacting a pattern region neighboring the pattern region not being filled with curable resin.

13. The pattern forming method according to claim 12, wherein the correcting the determined amount of the curable resin includes decreasing the determined amount of the curable resin on a region of the substrate contacting the pattern region not being filled with curable resin.

14. The pattern forming method according to claim 12, further comprising inspecting the pattern formed on the substrate after the template is released from the cured curable resin.

15. The imprint method according to claim 12, wherein the inspecting the includes changing inspection sensitivity in accordance with density of the pattern in the plurality of pattern regions, the inspection sensitivity includes a first inspection sensitivity and a second inspection sensitivity lower than the first inspection sensitivity, density of the pattern in the plurality of pattern regions inspected by the second inspection sensitivity is lower than density of the pattern in the plurality of pattern regions inspected by the first inspection sensitivity.

16. The imprint method according to claim 15, wherein the pattern in the plurality of pattern regions inspected by the first and second inspections are inspected by optical inspection apparatus.

17. A computer program product configured to store program instructions for execution on a computer system enabling the computer system to perform:
an instruction to dividing a pattern to be formed on a template into a plurality of pattern regions,
an instruction to determine amount of curable resin for each of a plurality of regions of a substrate, wherein the plurality of regions of the substrate contact the plurality of pattern regions of the pattern when the template is contacted with the curable resin,
an instruction to determine whether the pattern of the template is filled with the curable resin having the determined amount within predetermined time for each of the plurality of pattern regions, and
an instruction to correct the determined amount of the curable resin when the plurality of pattern regions includes a pattern region which is determined not to be filled with the curable resin within the predetermined time, wherein the correcting the determined amount is performed based on the relationship between the density or shape of the pattern to be formed on the template and the filling time for filling the pattern to be formed on the template.
